(19) United States
(12) Patent Application Publication
(10) Pub. No.: US 2019/0054666 A1
(43) Pub. Date: Feb. 21, 2019

(54) Treatment of Polymeric Surfaces of Objects

(71) Applicant: POLYMERTAL LTD., Haifa (IL)

(72) Inventors: Zeev Shpiro, Tel Aviv (IL); Natalia BOLCHTIANSKI, Nesher (IL)

(73) Assignee: Polymertal Ltd., Haifa (IL)

(21) Appl. No.: 14/898,458

(22) PCT Filed: Jun. 18, 2014
(86) PCT No.: PCT/IL2014/050553

§ 371 Date: Jul. 25, 2016

Related U.S. Application Data
(60) Provisional application No. 61/836,425, filed on Jun. 18, 2013.

(51) Int. Cl. B29C 35/02; B29C 71/00; B29C 71/02; C08J 7/02

(52) U.S. Cl. CPC B29C 35/0266; B29C 71/0009; B29C 64/00; C08J 7/02; B29C 2071/022; B29C 71/02

(57) ABSTRACT

There are disclosed methods for reforming a polymeric surface of an article formed, for example, by additive process molding, and articles read in accordance with this process. The reforming of the surface results in reduced surface roughness such that the article is similar in surface smoothness to an article made by injection molding.

### CROSS REFERENCES TO RELATED APPLICATIONS

This application is related to and claims priority from U.S. Provisional Patent Application Ser. No. 61/836,425, filed 18 Jun. 2013, entitled: Surface Treatment of Plastic Objects, the disclosure of which is incorporated by reference herein in its entirety.

### TECHNICAL FIELD

The present invention is related to surface treatment of articles with polymeric surfaces, including plastic surfaces.

### BACKGROUND

Polymeric articles and articles with polymeric surfaces formed by techniques such as additive process modeling, also known as rapid prototyping or rapid manufacturing, result in articles with rough surfaces and sometimes also porous, and in the case of polymeric surfaces, these surfaces are rough and sometimes also porous. The surfaces of these articles do not have the surface smoothness possessed by injection molded plastic articles.

For example, FIGS. 1A and 1B show an article 10 with a surface 12, produced by additive process modeling. The surface 12 is porous and rough, for example, with a roughness of greater than 40μ peak to peak, as the surface grooves 14 include peaks of greater than 40 micrometers (microns). The object may be, for example, approximately 20 cm in height.

FIG. 1C shows an exemplary surface 20, including a baseline 21 from which roughness (R_{z}) and Average Roughness (Rₐ) values are taken based on peak to peak (PP) measurements of the peaks 22a-22n on the surface 20. The individual roughnesses are represented by R_{z} values while the average roughness Rₐ is an average value for the peak to peak (PP) roughness.

### SUMMARY OF THE INVENTION

According to an aspect of some embodiments of the present invention there is provided methods for reforming a polymeric surface of an article formed, for example, by additive process molding, and articles created in accordance with this process. The reforming of the surface results in reduced surface roughness such that the article is similar in surface smoothness to an article made by injection molding.

In accordance with embodiments of the invention, there is provided a method for reducing roughness of a polymeric surface of an article produced by additive manufacturing. The method comprises, applying a liquid solvent by immersion of the polymeric surface of the article, in the liquid solvent to create a gel layer; and, curing the gel layer to reform the at least a portion of the polymer surface by decreasing the roughness of the at least a portion of the polymer surface.

Optionally, the method additionally comprises removing the solvent from the article.

Optionally, the curing includes heating the gel layer to at least the glass transition temperature of the polymer of the polymeric surface.

Optionally, the applying the liquid solvent by immersion includes immersing the article in a bath to create the gel layer.

Optionally, the applying the liquid solvent by immersion includes immersing the article into a flow of the liquid solvent to create the gel layer.

Optionally, the gel layer is of a thickness of the same order of magnitude as the roughness of the polymeric surface.

Optionally, the gel layer thickness is approximately 0.3 to 3 times the average roughness (Ra) of the polymeric surface.

Optionally, the removing the solvent includes removing substantially all of the solvent from the article prior to the completion of the curing of the gel layer.

Optionally, the removing the solvent is performed by a processes selected from at least one of heating and pulling a vacuum.

Optionally, the polymeric surface is selected from at least one of polymers including Polyetherimide (PEI), ULTEM®, Acrylonitrile Butadiene Styrene (ABS), Polycarbonate (PC), PC-ABS, Polyamide (PA), Nylon, Polyethylene, and Poly Methyl Methacrylate (PMMA).

In accordance with embodiments of the invention, there is provided an article including at least a portion of a polymeric surface made by a process. The process comprises, obtaining an article with a polymeric surface defining at least a portion of the surface of the article; applying a liquid solvent by immersion of the polymeric surface of the article, in the liquid solvent to create a gel layer; and, curing the gel layer to reform the at least a portion of the polymer surface by decreasing the roughness of the at least a portion of the polymer surface.

Optionally, the process additionally comprises removing the solvent from the article.

Optionally, the curing includes heating the gel layer to at least the glass transition temperature of the polymer of the polymeric surface.

Optionally, the applying the liquid solvent by immersion includes immersing the article in a bath to create the gel layer.

Optionally, the applying the liquid solvent by immersion includes immersing the article into a flow of the liquid solvent to create the gel layer.

Optionally, the gel layer is of a thickness of the same order of magnitude as the roughness of the polymeric surface.

Optionally, the gel layer thickness is approximately 0.3 to 3 times the average roughness (Ra) of the polymeric surface.

Optionally, the removing the solvent includes removing substantially all of the solvent from the article prior to the completion of the curing of the gel layer.

Optionally, the removing the solvent is performed by a process of at least one of heating and pulling a vacuum.

Optionally, the polymeric surface is selected from at least one polymer including Polyetherimide (PEI), ULTEM®, Acrylonitrile Butadiene Styrene (ABS), Polycarbonate (PC), PC-ABS, Polyamide (PA), Nylon, Polyethylene, and Poly Methyl Methacrylate (PMMA).

In accordance with embodiments of the invention, there is an article made by an additive manufacturing process with a surface of a first roughness, the article including a surface of a second roughness, less than the first roughness, the surface of the second roughness having been reformed from a cured gel layer, having a different molecular structure than the structure of the article made by the additive manufacturing process.

Optionally, the thickness of the reformed surface layer is of the same order of magnitude as the roughness of the surface of the article made by the additive manufacturing process prior to the surface having been reformed.

Optionally, the article is of a material selected at least one polymer including, Polyetherimide (PEI), ULTEM®, Acrylonitrile Butadiene Styrene (ABS), Polycarbonate (PC), PC-ABS, Polyamide (PA), Nylon, Polyethylene, and Poly Methyl Methacrylate (PMMA).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Attention is now directed to the drawing figures where like numerals and/or characters indicate corresponding or like elements. In the drawings:

FIG. 1A is an article made by additive process modeling with a rough surface;

FIG. 1B is an illustration of the surface of the article of FIG. 1A;

FIG. 1C is an illustration of how the surface values of Roughness (R_{Z}) and Average Roughness (Rₐ) are measured;

FIG. 2 is a flow diagram of a process in accordance with embodiments of the present invention;

FIG. 3A is the article of FIGS. 1A and 1B after the process of embodiments of the present invention have been performed on it to reduce surface roughness; and,

FIG. 3B is an illustration of the surface of the article of FIG. 3A.

### DETAILED DESCRIPTION OF THE DRAWINGS

The present invention will now be shown and described in accordance with the drawing figures and the examples detailed below.

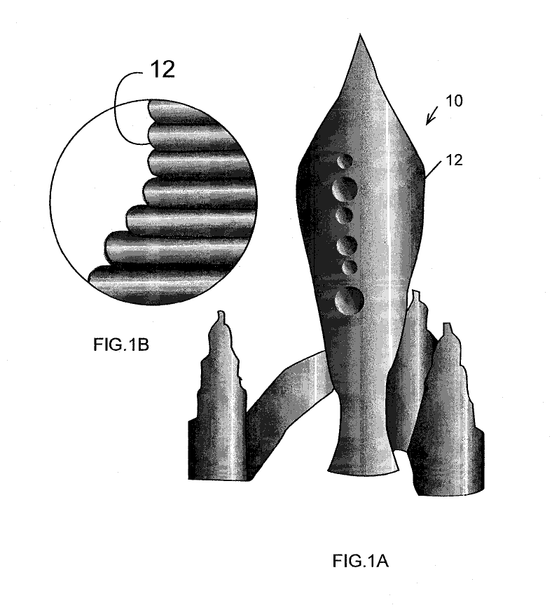

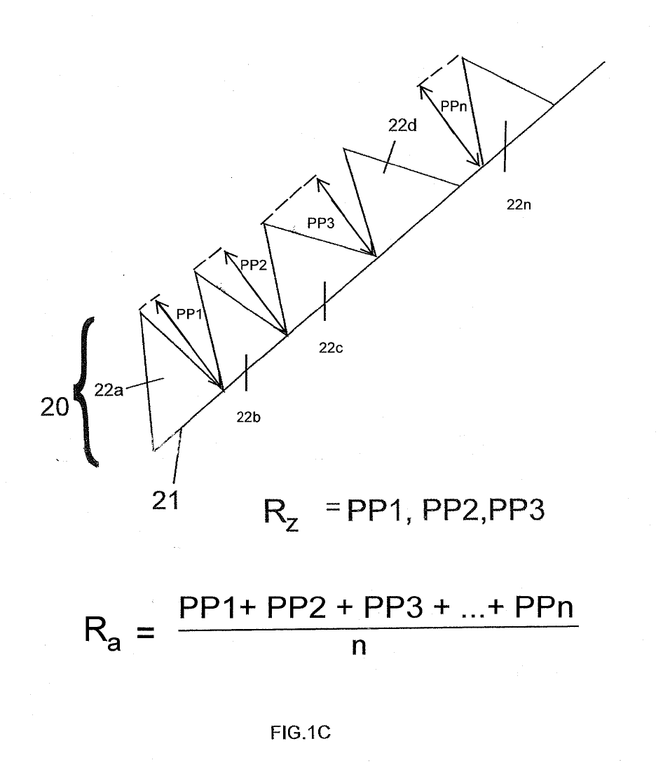

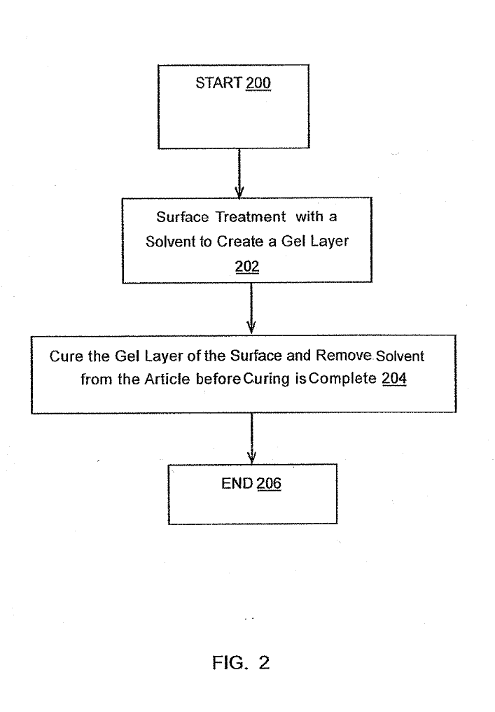

Referring to FIG. 2, there is shown a flow diagram of a process for reducing surface roughness of, for example, an article (also known as an object, the terms “article” and “object” used interchangeably herein) including a polymeric surface or a portion of the surface includes a polymeric material. The article is obtained at the START block 200. The article may be, for example, a polymeric article including at least a polymeric surface, made by techniques, for example, additive manufacturing or additive process modeling, which includes methods such as three dimensional (3D) printing. The article may be for example, the article 10 of FIGS. 1A and 1B.

The article is subjected to a surface treatment with a solvent, for example, a liquid solvent. This begins a dissolution process of the rough surface. The dissolution process is not immediate, but rather is stopped when a gel layer of a desired thickness is produced on the outside of the article. This dissolution process is also influenced by several factors, including, for example, the surface material (e.g., polymer), solvent, and, temperature. As part of the process of the surface treatment with the solvent, a surface gel layer is created, at block 202. This dissolution process is such that it affects at least the outer rough and sometime also porous layers of the article. The dissolution is such that it creates at least a gel layer on the surface. For example, the gel layer contains swollen polymer material in a rubber-like state.

One or more layers of the surface of the article (e.g., the polymeric surface, also known as surface layers) in addition to the gel layer (also a surface layer), may be created by the diffusion of the solvent into the article. These additional surface layers are located both above and below the gel layer. For example, immediately above the gel layer may be a liquid layer. Under the gel layer may be a solid swollen layer, with an infiltration layer below the solid swollen layer. The infiltration layer overlies a pure polymer layer of the surface. The gel layer as well as the aforementioned additional layers, one or more of which may be present in addition to the gel layer, which are created by the aforementioned diffusion are detailed, for example, in Miller-Chou, et al., “A review of Polymer Dissolution,” Progress In Polymer Science, Vol. 28 (2003) pp. 1223-1270, this document incorporated by reference in its entirety herein. The dissolution process is stopped before the dissolution of the gel layer, and while the gel layer is at a desired thickness. The stopping can be done by disconnecting the interaction between the solvent and the article (e.g., taking the article out from the immersion, such as a solvent bath) or using a different chemical process (e.g. interaction with different solvent), or washing in water).

The gel layer, which is typically desired, is of dimensions, for example, a thickness of the same order of magnitude as the surface roughness, such as the average roughness (Ra) of the polymeric surface of the article. This thickness, for example, is typically approximately 0.3 to 3 times the average roughness (Ra). The minimum thickness should be such that it covers the most (at least substantially all) of the surface roughness, and, for example, has a minimum thickness of approximately 3-5 microns, while, for example, the maximum thickness should be such that there is a workable gel layer, that does not change the dimensions of the finished object appreciably (for example, within approximately up to 40 microns), once the gel layer is cured and the smooth surface for the article has been formed.

The solvent is, for example, either polar or nonpolar. Polar solvents include, for example, organic solvents such as dichloromethane, dimethyl sulfoxide (DMSO), acetonitrile, tetrahydrofuran, dimethylformamide (DMF) (e.g., n, n-dimethylformamide, n, n-dimethylacetamide, and, n, n-dimethylbutanamide) N-Methyl-2-pyrrolidone (NMP), ethyl acetate, methyl acetate, acrylonitrile, acetic acid, acetone, Cresol, dichloroethane, ethyl alcohol, trichloroethane (e.g., tricholorethane 1, 1, 1), n, n-dimethylethanamine, methyl ethyl ketone, chloroform, butyl alcohol, Carbon Disulphide, diethanolamine, Ethylene Glycol, acetic acid, and formic acid. Polar inorganic solvents include acids, such as sulfuric acid, nitric acid, and Sodium Hypochlorite solution. Non-polar solvents include, for example, carbon tetrachloride, cyclohexanone, hexane, and xylenes.

The aforementioned solvents may be used separately or in combinations or mixtures thereof. The actual solvent or solvent mixture used may be selected depending on the material of the polymeric surface being treated, in accordance with the disclosed embodiments. For example, the liquid solvent selected is typically thermodynamically compatible with the polymer of the polymeric surface.

The solvent is applied, for example, by immersion of the article in a bath of the liquid solvent, or other immersion technique, such as in a stream of flowing solvent, where the entire treated surface is contacted with the liquid solvent. The immersion is for example, over a time period sufficient to create the minimum thickness gel layer, as detailed above. This time period for solvent application via a bath may be, for example, from approximately two minutes, to approximately 20 minutes.

The solvent may be at a temperature, in accordance with the polymeric material of the polymeric surface. For example, the solvent temperature typically ranges from approximately Room Temperature (RT) to a temperature that is lower than the glass transition (T_{g}) of the polymer of the surface. For example, the temperature is up to approximately 80 degrees Celsius. With the solvent at these temperatures, the aforementioned diffusion creates the gel layer of the desired thickness.

The process now moves to block 204. In block 204, the gel layer of the surface is cured and solvent is removed from the article before the curing is complete. The curing also removes the solvent from the gel layer (and any surface layers above the gel layer), with any additional solvent in the article or other layers of the article, below the gel layer. Regardless of when the solvent is removed from any of the surface layers of the article, almost all (except trace amounts) of the solvent (and all of the solvent, if possible) must be removed from the article prior to the curing being completed, so that solvent particles are not trapped in the finished article with the reformed surface. Failure to remove the solvent may result in bubbles on the surface when the article is being heated.

For example, when heating is the process used for the curing and solvent removal, the oven may be kept at a single temperature or started at one temperature and gradually increased to another temperature, at various selected time intervals. The time of curing and solvent removal in the oven may be, for example, approximately 1.5 hours to approximately 14 hours with the oven heated to temperatures of approximately 20 degrees C. to approximately 180 degrees C., and for example, the oven should be heated to approximately the glass transition temperature (T_{g}) of the polymer of the polymeric surface being treated, for example, to complete the curing.

The curing causes the molecules in the gel layer of the surface to reform, by, for example, molecular reorganization. The curing occurs, for example, as the gel layer is heated to at least approximately the glass transition temperature (T_{g}) of the polymer of the polymeric surface, and for example, in an oven, or the like. This curing typically occurs for a time period of approximately 1.5 hours to approximately 14 hours, depending on the temperature to which the oven is heated. The cure is complete when the gel layer has hardened to at least approximately the initial hardness of the original article, prior to undergoing the surface treatment as disclosed herein.

The solvent may also be removed by pulling a vacuum, by placing the article, for example, in a vacuum chamber of a vacuum oven, such that the vacuum causes the evaporation, coupled with the aforementioned heating in the oven. The vacuum may be, for example, approximately 100-250 Torr. For example, the solvent is typically removed prior to the completion of the curing of the gel layer. The vacuum oven can operate in steps, for example, performing a temperature raising operation and/or heating operation prior to performing a vacuum process. This heating absent a vacuum is typically performed as the article or object is typically wet or most at the surface after evaporation by pulling the vacuum.

The diffusion and the rate of dissolution of the solvent during solvent removal are significantly influenced by the molar volume of solvent. This is because the diffusion of solvent into polymer and the rate of dissolution also depend on molecular structure of polymer and physicochemical properties of solvent.

With the curing and/or evaporation complete, the process moves to block 206 where it ends. The article is removed from the oven, vacuum oven, or other treatment apparatus.

For example, if the surface treated is Nylon 12 or Acrylonitrile butadiene styrene (ABS), the curing process and solvent removal process are performed in an oven such as a ventilated oven. For example, if the surface treated is Ultem®, the curing process and the solvent removal process are typically performed in a vacuum oven.

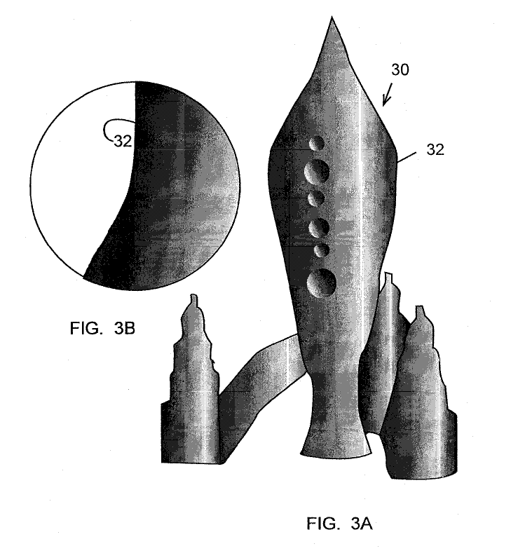

The curing of the gel layer and removal of the solvent has resulted in an article 30 with a reformed surface 32, as shown in FIG. 3. The reformed surface 32 is of reduced surface roughness, and a different molecular structure, when compared to the surface 12 (and its molecular structure) of the article 10 prior to the disclosed surface treatment. The surface 32, now reformed, is smooth, characterized by a roughness of less than the surface roughness of the original device 10, before undergoing the disclosed surface treatment process. The article 30 is of the same dimensions as the article 10 before the disclosed surface treatment, as only a trace amount of surface material was removed during the polymer dissolution process during its initial steps, until the process is stopped. Alternatively, if some polymeric material is being dissolved, and the dimensions of the articles are being changed, since the process is repeatable, this information can be taken into consideration when the article is being designed and made, so the final dimensions after the surface treatment comply with the original article dimensions. The now finished article may be painted or coated.

The polymers of the polymeric surfaces include, for example, Polyetherimide (PEI) ULTEM®, Acrylonitrile Butadiene Styrene (ABS), Polycarbonate (PC), PC-ABS, Polyamide (PA) Nylon (including, for example, Nylon12), Polyethylene, Poly Methyl Methacrylate (PMMA) and combinations thereof. The articles subject to the surface treatment are made by processes such as additive process modeling, also known as rapid prototyping, which includes three dimensional (3D) printing.

### EXAMPLES

### Example 1

### ULTEM Surface Treatment:

### Process Steps:

1. Taking an article made from Ultem® 9085, by Fused Deposition Molding (FDM) additive manufacturing process and Stratasys Fortus machine, with an average surface roughness of 15 microns.
2. Surface cleaning with Alkaline Detergent Cleaning solution.
3. Polymer Dissolution/Gel Layer Creation:
   Immersing the article surface in solvent:
   100% Solvent of NMP in a bath at 60-80° C. for 3-10 min
   or;
   100% solvent of n, n-dimethylethanamine in a bath at 70-80° C. for 3-10 min;
4. Curing and Solvent Removal in a vacuum oven ramping up from 40° C. to maximum working temperature (less than 155° C.) in approximately 12 hours in the following manner:
   1. Put the article in a pre-heated oven at 40-45° C.
   2. Keep the article in the oven for at least 30 min,
   3. Build a vacuum of approximately 100-250 Torr for 30 minutes, and release the vacuum.
   4. Increase the oven temperature by 30-40° C. at a rate of 0.5° C./minute
Repeat the above steps 2-4, until reaching the maximal working temperature. Continue for 3-4 hours at the maximum working temperature.
5. Results:
   Average surface roughness of the ULTEM article was reduced from 15 microns to 0.76 microns.

### Example 2

### Nylon 12 Surface Treatment:

### Process Steps:

1. Taking an article made from Nylon 12, by an EOS additive manufacturing process and equipment (e.g., EOS P 395 or EOSINT device), with an average surface roughness of 19.7 microns.
2. Surface cleaning with Alkaline Detergent Cleaning solution.
3. Polymer Dissolution/Gel Layer Creation:
   Immersing the article surface in solvents:
      Mixture of 50% solvent of Acetic Acid and 50% solvent of Formic Acid (by volume) in a bath at 70-80° C. for 3-10 minutes.
4. Curing and Solvent Removal in oven with ventilation ramping upward from at 30° C. to 120° C.-130° C. at 1° C./minute and continue for 3-4 hours at 120° C.-130° C.
5. Results:
   Average surface roughness of the Nylon 12 article was reduced from 19.7 microns to 2.05 microns.

### Example 3

### ABS Surface Treatment:

### Process Steps:

1. Taking an article made from ABS, by FDM additive manufacturing process and Stratasys equipment, with an average surface roughness of 15.9 microns.
2. Surface cleaning with Alkaline Detergent Cleaning solution.
3. Polymer Dissolution/Gel Layer Creation:
   Immersing the article surface in solvents:
      Solvent Mixture of 40-90% NMP, 5-30% Trichloroethane 1, 1, and 5-20% Ethyl Alcohol in a bath at room temperature (RT) for 1-10 min;
   Or:
      100% Solvent of NMP in a bath at RT for 1-10 min.
4. Curing and Solvent Removal in an oven with ventilation ramping up from 30° C. to 80° C. at 0.5° C./minute, and continuing for 3-4 hours at 80° C.
5. Results: The average surface roughness of the ABS article was reduced from 15.9 microns to 0.15 microns.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for reducing roughness of a polymeric surface of an article produced by additive manufacturing, comprising:
applying a liquid solvent by immersion of the polymeric surface of the article in the liquid solvent to create a gel layer; and,
curing the gel layer to reform at least a portion of the polymeric surface by decreasing the roughness of the at least a portion of the polymeric surface.

2. The method of claim 1, additionally comprising: removing the solvent from the article.

3. The method of claim 1, wherein the curing includes heating the gel layer to at least the glass transition temperature of the polymer of the polymeric surface.

4. The method of claim 1, wherein the applying the liquid solvent by immersion includes immersing the article in a bath to create the gel layer.

5. The method of claim 1, wherein the applying the liquid solvent by immersion includes immersing the article into a flow of the liquid solvent to create the gel layer.

6. The method of claim 1, wherein the gel layer is of a thickness of the same order of magnitude as the roughness of the polymeric surface.

7. The method of claim 6, wherein the gel layer thickness is approximately 0.3 to 3 times the average roughness (Ra) of the polymeric surface.

8. The method of claim 2, wherein the removing the solvent includes removing substantially all of the solvent from the article prior to the completion of the curing of the gel layer.

9. The method of claim 8, wherein the removing the solvent is performed by a process selected from the group consisting of: heating and pulling a vacuum.

10. The method of claim 1, wherein the polymeric surface is selected from the group of polymers consisting of Polyetherimide (PEI), ULTEM®, Acrylonitrile Butadiene Styrene (ABS), Polycarbonate (PC), PC-ABS, Polyamide (PA), Nylon, Polyethylene, and Poly Methyl Methacrylate (PMMA).

11. An article including at least a portion of a polymeric surface made by a process comprising:
obtaining an article with a polymeric surface defining at least a portion of the surface of the article;
applying a liquid solvent by immersion of the polymeric surface of the article in the liquid solvent to create a gel layer; and
curing the gel layer to reform the at least a portion of the polymeric surface by decreasing the roughness of the at least a portion of the polymeric surface.

12. The article of claim 11, wherein the process additionally comprises: removing the solvent from the article.

13. The article of claim 11, wherein the curing includes heating the gel layer to at least the glass transition temperature of the polymer of the polymeric surface.

14. The article of claim 11, wherein the applying the liquid solvent by immersion includes immersing the article in a bath to create the gel layer.

15. The article of claim 1, wherein the applying the liquid solvent by immersion includes immersing the article into a flow of the liquid solvent to create the gel layer.

16. The article of claim 11, wherein the gel layer is of a thickness of the same order of magnitude as the roughness of the polymeric surface.

17. The article of claim 16, wherein the gel layer thickness is approximately 0.3 to 3 times the average roughness (Ra) of the polymeric surface.

18. The article of claim 12, wherein the removing the solvent includes removing all of the solvent from the article prior to the completion of the curing of the gel layer.

19. The article of claim 18, wherein the removing the solvent is performed by a process selected from the group consisting of: heating and pulling a vacuum.

20. The article of claim 11, wherein the polymeric surface is selected from the group of polymers consisting of Polyetherimide (PEI), ULTEM®, Acrylonitrile Butadiene Styrene (ABS), Polycarbonate (PC), PC-ABS, Polyamide (PA), Nylon, Polyethylene, and Poly Methyl Methacrylate (PMMA).

21. An article made by an additive manufacturing process with a surface of a first roughness, the article including a surface of a second roughness, less than the first roughness, the surface of the second roughness having been reformed from a cured gel layer having a different molecular structure than the structure of the article made by the additive manufacturing process.

22. The article of claim 21, wherein the thickness of the reformed surface layer is of the same order of magnitude as the roughness of the surface of the article made by the additive manufacturing process prior to the surface having been reformed.

23. The article of claim 22, wherein the article is of a material selected from the group of polymers consisting of Polyetherimide (PEI), ULTEM®, Acrylonitrile Butadiene Styrene (ABS), Polycarbonate (PC), PC-ABS, Polyamide (PA), Nylon, Polyethylene, and Poly Methyl Methacrylate (PMMA).
